(19) United States
(12) Patent Application Publication
(10) Pub. No.: US 2025/0165133 A1
(43) Pub. Date: May 22, 2025

(54) DISPLAY APPARATUS FOR PROVIDING MULTI-WINDOW FUNCTION AND CONTROLLING METHOD THEREOF

(71) Applicant: SAMSUNG ELECTRONICS CO., LTD., Suwon-si (KR)

(72) Inventors: Jooyoun KIM, Suwon-si (KR); Nayoung KOH, Suwon-si (KR); Sangjin HAN, Suwon-si (KR); Sugyeong HYEON, Suwon-si (KR)

(73) Assignee: SAMSUNG ELECTRONICS CO., LTD., Suwon-si (KR)

(21) Appl. No.: 19/018,970

(22) Filed: Jan. 13, 2025

Related U.S. Application Data
(63) Continuation of application No. PCT/KR2024/096406, filed on Oct. 29, 2024.

(30) Foreign Application Priority Data
Nov. 21, 2023 (KR) 10-2023-0162349

(51) Int. Cl. G06F 3/04845; G06F 3/04817; G06F 3/04842

(52) U.S. Cl. CPC G06F 3/04845; G06F 3/04817; G06F 3/04842

(57) ABSTRACT

A display apparatus is provided. The display apparatus includes: a communication interface; a display; at least one memory storing one or more instructions; and at least one processor, wherein the at least one processor is configured to execute the one or more instructions, and wherein the one or more instructions, when executed by the at least one processor, cause the display apparatus to: control the display to display content received from an electronic apparatus through the communication interface on a first area of the display, based on a size of the first area being adjusted according to a user command, transmit information regarding the adjusted size to the electronic apparatus through the communication interface, and based on receiving additional content corresponding to the resized first area from the electronic apparatus, control the display to display the additional content on the resized first area.

### CROSS-REFERENCE TO RELATED APPLICATIONS

This application is a by-pass continuation of International Application No. PCT/KR2024/096406, filed on Oct. 29, 2024, which is based on and claims priority to Korean Patent Application No. 10-2023-0162349, filed in the Korean Intellectual Property Office on Nov. 21, 2023, the disclosures of which are incorporated by reference herein in their entireties.

### BACKGROUND

### 1. Field

The present disclosure relates to a display apparatus and a controlling method thereof, and more particularly, to a display apparatus for providing a multi-window function and a controlling method thereof.

### 2. Description of Related Art

With the development of electronic technology, electronic apparatuses that provide various functions are being developed. In particular, various electronic blackboards have been developed in recent years, improving the convenience of many users.

However, prior art electronic blackboards do not support a multi-window function, or even if they support multi-tasking, the electronic blackboards are switched only to full screen which suffer from an inability to display content from multiple sources on a single screen.

Alternatively, prior art electronic blackboards provide the function of displaying a plurality of pieces of content simultaneously, such as a multi-view function, but the function is used only in a preset layout and it is difficult to switch between tasks.

Accordingly, there is a need to develop apparatuses capable of switching between tasks more freely.

### SUMMARY

Provided is a display apparatus that provides a multi-window function to display each task as a separate window and make it easier to switch between tasks, and a method of controlling same.

According to an aspect of the disclosure, a display apparatus includes: a communication interface; a display; at least one memory storing one or more instructions; and at least one processor connected to at least one memory, the communication interface and the display, wherein the at least one processor is configured to execute the one or more instructions, and wherein the one or more instructions, when executed by the at least one processor, cause the display apparatus to: control the display to display content received from an electronic apparatus through the communication interface on a first area of the display, based on a size of the first area being adjusted according to a user command, transmit information regarding the adjusted size to the electronic apparatus through the communication interface, and based on receiving additional content corresponding to the resized first area from the electronic apparatus, control the display to display the additional content on the resized first area.

A resolution of the additional content may be based on the information regarding the adjusted size.

The one or more instructions, when executed by the at least one processor, may further cause the display apparatus to: based on the user command being input, provide a GUI for guiding adjustment of the size of the first area based on information received from the electronic apparatus, through the communication interface, regarding one or more available area sizes.

The one or more instructions, when executed by the at least one processor, may further cause the display apparatus to: based on the size of the first area being adjusted according to the user command, identify whether the adjusted size corresponds to one of the one or more available area sizes, based on the adjusted size not corresponding to one of the one or more available area sizes, readjust the adjusted size to one of the one or more available area sizes, and transmit information regarding the readjusted size to the electronic apparatus through the communication interface.

The one or more instructions, when executed by the at least one processor, may further cause the display apparatus to: control the display to display second content received from a second electronic apparatus through the communication interface on a second area of the display, and control the display to display a task bar including an indicator corresponding to the content and a second indicator corresponding to the second content.

The one or more instructions, when executed by the at least one processor, may further cause the display apparatus to: based on receiving a user command to select the indicator or the second indicator, change a display state of content corresponding to the selected indicator based on a priority of the content corresponding to the selected indicator.

The one or more instructions, when executed by the at least one processor, may further cause the display apparatus to: based on the priority of the content corresponding to the selected indicator being lower than a priority of remaining content, control the display to display an area where the content corresponding to the selected indicator and the other content overlap, and based on the priority of the content corresponding to the selected indicator being higher than a priority of the remaining content, control the display to display the content corresponding to the selected indicator on an entire area of the display.

The one or more instructions, when executed by the at least one processor, may further cause the display apparatus to: based on the priority of content corresponding to the selected indicator being higher than the priority of the remaining content, transmit through the communication interface information regarding the entire area to an apparatus that provides the content corresponding to the selected indicator.

The one or more instructions, when executed by the at least one processor, may further cause the display apparatus to: identify at least one of a size or a resolution of the first area based on a type of the content.

The one or more instructions, when executed by the at least one processor, may further cause the display apparatus to: based on identifying that the electronic apparatus is connected to the display apparatus through the communication interface, transmit information regarding a size of the first area to the electronic apparatus through the communication interface, and wherein a resolution of the content corresponding to the first area is based on the information regarding the size of the first area.

The information regarding the adjusted size may include extended display identification data regarding the adjusted size.

The one or more instructions, when executed by the at least one processor, may further cause the display apparatus to: based on the size of the first area being adjusted, control the display to display a preset image on the first area.

According to an aspect of the disclosure, a method of controlling a display apparatus includes: displaying content received from an electronic apparatus on a first area of a display included in the display apparatus; based on a size of the first area being adjusted according to a user command, transmitting information regarding the adjusted size to the electronic apparatus; and based on receiving additional content corresponding to the resized first area from the electronic apparatus, displaying the additional content on the resized first area.

A resolution of the additional content may be based on the information regarding the adjusted size.

The method may further include: based on the user command is being input, providing a GUI for guiding adjustment of the size of the first area based on information received from the electronic apparatus regarding one or more available sizes.

The method may further include: displaying second content received from a second electronic apparatus on a second area of the display; and displaying a task bar including an indicator corresponding to the content and a second indicator corresponding to the second content.

According to an aspect of the disclosure, a non-transitory computer readable medium having instructions stored therein, which when executed by at least one processor, cause the at least one processor to execute a method of controlling a display apparatus, the method including: displaying content received from an electronic apparatus on a first area of a display included in the display apparatus; based on a size of the first area being adjusted according to a user command, transmitting information regarding the adjusted size to the electronic apparatus; and based on receiving additional content corresponding to the resized first area from the electronic apparatus, displaying the additional content on the resized first area.

With regard to the method executed based on the instruction stored in the non- transitory computer readable medium, a resolution of the additional content may be based on the information regarding the adjusted size.

With regard to the method executed based on the instruction stored in the non- transitory computer readable medium, the method may further include: based on the user command is being input, providing a GUI for guiding adjustment of the size of the first area based on information received from the electronic apparatus regarding one or more available sizes.

According to an aspect of the disclosure, a display apparatus includes: a communication interface; a display; at least one memory storing one or more instructions; and at least one processor connected to at least one memory, the communication interface and the display, wherein the at least one processor is configured to execute the one or more instructions, and wherein the one or more instructions, when executed by the at least one processor, cause the display apparatus to: control the display to display content received from an electronic apparatus through the communication interface on a first area of the display, based on the size of the first area being adjusted according to a user command, identify whether the adjusted size corresponds to one of one or more available area sizes based on information regarding the one or more available area sizes received from the electronic apparatus through the communication interface, based on the adjusted size corresponding to one of the one or more available area sizes, transmit information regarding the adjusted size to the electronic apparatus through the communication interface, based on the adjusted size not corresponding to one of the one or more available area sizes, readjust the adjusted size to one of the one or more available area sizes and transmit information regarding the readjusted size to the electronic apparatus through the communication interface, and based on receiving additional content corresponding to the resized first area from the electronic apparatus, control the display to display the additional content on the resized first area.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram illustrating configuration of a display apparatus according to an embodiment;

FIG. 2 is a block diagram illustrating a more detailed configuration of a display apparatus according to an embodiment;

FIG. 3 is a view illustrating a screen on which a window is displayed according to an embodiment;

FIG. 4 is a view provided to explain a size change of a window according to an embodiment;

FIG. 5 is a view provided to explain information regarding an adjusted size according to an embodiment;

FIG. 6 is a view provided to explain a multi-window and a task bar according to an embodiment;

FIG. 7 is a view provided to explain an operation in response to a manipulation of a task bar according to an embodiment;

FIG. 8 is a view provided to explain information regarding a size that can be provided by an electronic apparatus according to an embodiment;

FIG. 9 is a view provided to explain an operation of adjusting a size of a window according to an embodiment;

FIG. 10 is a view provided to explain an operation of displaying a decorator according to an embodiment;

FIG. 11 is a view provided to explain an operation in response to a manipulation of a task bar according to an embodiment;

FIG. 12 is a view provided to explain a mode for arranging a plurality of windows according to an embodiment;

FIGS. 13 and 14 are views provided to explain a scenario where a display apparatus is turned on according to an embodiment;

FIG. 15 is a view provided to explain a method of automatically arranging a plurality of windows according to an embodiment;

FIG. 16 is a view provided to explain a method of identifying a first area in response to a type of content according to an embodiment;

FIG. 17 is a view provided to explain a method of disposing areas by type of content according to an embodiment; and

FIG. 18 is a flowchart provided to explain a method of controlling a display apparatus according to an embodiment.

### DETAILED DESCRIPTION

The embodiments of the present disclosure may be diversely modified. Accordingly, specific exemplary embodiments are illustrated in the drawings and are described in detail in the detailed description. However, it is to be understood that the present disclosure is not limited to a specific exemplary embodiment, but includes all modifications, equivalents, and substitutions without departing from the scope and spirit of the present disclosure. Also, well-known functions or constructions are not described in detail since they would obscure the disclosure with unnecessary detail.

Hereinafter, the present disclosure will be described in detail with reference to the accompanying drawings.

General terms that are currently widely used are selected as the terms used in the embodiments of the disclosure in consideration of their functions in the disclosure, but may be changed based on the intention of those skilled in the art or a judicial precedent, the emergence of a new technique, or the like. In addition, specific cases, terms arbitrarily chosen by an applicant may exist. In such cases, the meanings of such terms are mentioned in detail in the corresponding descriptions of the disclosure. Therefore, the terms used in the embodiments of the disclosure need to be defined on the basis of the meanings of the terms and the overall contents throughout the disclosure rather than simple names of the terms.

In the disclosure, an expression “have”, “may have”, “include”, “may include” or the like, indicates the existence of a corresponding feature (e.g., a numerical value, a function, an operation or a component such as a part), and does not exclude the existence of an additional feature.

As used herein, an expressions such as “at least one of A or B” and “at least one of A and B” should be understood as indicating any one of “A”, “B” and “both of A and B.”

Expressions “1st”, “2nd”, “first”, “second”, and the like, used in the disclosure may indicate various components regardless of the sequence and/or importance of the components. These expressions are used only to distinguish one component from another component, and do not limit the corresponding components.

A term of a singular form may include its plural form unless explicitly indicated otherwise in the context. It is to be understood that a term “include”, “formed of”, or the like used in the application specifies the presence of features, numerals, steps, operations, components, parts, or combinations thereof, mentioned in the specification, and does not preclude the presence or addition of one or more other features, numerals, steps, operations, components, parts, or combinations thereof.

In the disclosure, the term “user” may refer to a person using a display apparatus or a device (e.g., an artificially intelligent electronic apparatus) using a display apparatus.

Hereinafter, various embodiments of the present disclosure will be described in greater detail with reference to the accompanying drawings.

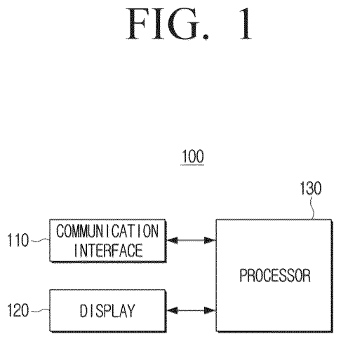

FIG. 1 is a block diagram illustrating configuration of a display apparatus 100 according to an embodiment.

The display apparatus 100 is a device that displays content and has a display, such as a TV, desktop PC, laptop, smartphone, tablet PC, electronic blackboard, or the like, and may be referred to as a sink device. Here, the display apparatus 100 is connected to at least one electronic apparatus that is referred to as a source device, and may receive content from the at least one electronic apparatus. However, the display apparatus 100 is not limited thereto, and the display apparatus 100 may be any device capable of displaying content.

As shown in FIG. 1, the display apparatus 100 may include a communication interface 110, a display 120, and a processor 130.

The communication interface 110 is configured to perform communication with various types of external devices according to various types of communication methods. For example, the display apparatus 100 may perform communication with a server or at least one electronic apparatus via the communication interface 110.

The communication interface 110 may include a Wi-Fi module, a Bluetooth module, an infrared communication module, a wireless communication module, and the like. Here, each communication module may be implemented in the form of at least one hardware chip.

The Wi-Fi module and the Bluetooth module perform communication using a Wi-Fi method and a Bluetooth method, respectively. When using a Wi-Fi module or a Bluetooth module, various connection information such as SSID and session keys are first transmitted and received, and various information can be transmitted and received after establishing a communication connection using the same. The infrared communication module performs communication according to an infrared Data Association (IrDA) communication technology which transmits data wirelessly over a short distance using infrared rays between optical light and millimeter waves.

In addition to the above-described communication methods, the wireless communication module may include at least one communication chip that performs communication according to various wireless communication standards, such as Zigbee, 3rd Generation (3G), 3rd Generation Partnership Project (3GPP), Long Term Evolution (LTE), LTE Advanced (LTE-A), 4th Generation (4G), 5th Generation (5G), etc.

Alternatively, the communication interface 110 may include a wired communication interface such as HDMI, DisplayPort, Thunderbolt, USB, RGB, D-SUB, DVI, etc.

In addition, the communication interface 110 may include at least one of a local area network (LAN) module, an Ethernet module, or a wired communication module that performs communication using pair cables, coaxial cables, fiber optic cables, etc.

The display 120 is configured to display an image, which can be implemented as various types of displays, such as liquid crystal displays (LCDs), organic light emitting diodes (OLEDs) displays, plasma display panels (PDPs), and the like. The display 120 may also include drive circuitry, backlight units, and the like, which may be implemented in the form of a-si TFTs, low temperature poly silicon (LTPS) TFTs, organic TFTs (OTFTs), and the like. The display 120 may be implemented as a touch screen combined with a touch sensor, a flexible display, a three-dimensional (3D) display, and the like.

The processor 130 may control the display 120 to display content.

Specifically, the processor 130 may be connected to each component of the display apparatus 100 to control the overall operations of the display apparatus 100. For example, the processor 130 may be connected to components such as the communication interface 110, the display 120, a memory 140, etc. to control the operations of the display apparatus 100.

The one or more processors may include one or more of a central processing unit (CPU), a graphics processing unit (GPU), an accelerated processing unit (APU), a many integrated core (MIC), a neural processing unit (NPU), a hardware accelerator, or a machine learning accelerator. The one or more processors may control one or any combination of the other components of the display apparatus 100, and may perform communication-related operations or data processing. The one or more processors may execute one or more programs or instructions stored in a memory. For example, the one or more processors may perform a method according to an embodiment by executing one or more instructions stored in the memory.

When a method according to an embodiment includes a plurality of operations, the plurality of operations may be performed by one processor or by a plurality of processors. For example, when a first operation, a second operation, and a third operation are performed by the method according to an embodiment, all of the first operation, the second operation, and the third operation may be performed by the first processor, or the first operation and the second operation may be performed by the first processor (e.g., a general-purpose processor) and the third operation may be performed by the second processor (e.g., an artificial intelligence- dedicated processor).

The one or more processors may be implemented as a single core processor comprising a single core, or as one or more multicore processors including a plurality of cores (e.g., homogeneous multicore or heterogeneous multicore). When the one or more processors are implemented as multicore processors, each of the plurality of cores included in a multicore processor may include a processor internal memory, such as a cache memory and an on-chip memory, and a common cache shared by the plurality of cores may be included in the multicore processor. Further, each of the plurality of cores (or some of the plurality of cores) included in the multi-core processor may independently read and perform program instructions to implement the method according to an embodiment, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment, all of the first operation, the second operation, and the third operation may be performed by the first core included in the multi-core processor, or the first operation and the second operation may be performed by the first core included in the multi-core processor and the third operation may be performed by the second core included in the multi-core processor.

In the embodiments of the present disclosure, the one or more processors may mean a system-on-chip (SoC) in which one or more processors and other electronic components are integrated, a single-core processor, a multi-core processor, or a core included in a single-core processor or multi-core processor. Here, the core may be implemented as CPU, GPU, APU, MIC, NPU, hardware accelerator, or machine learning accelerator, etc., but the core is not limited to the embodiments of the present disclosure. However, hereinafter, for convenience of explanation, the operation of the display apparatus 100 will be described using the term “processor 130.”

The processor 130 may control the display 120 to display content received from the electronic apparatus via the communication interface 110 on a first area of the display 120.

For example, the processor 130 may receive content from the electronic apparatus via the communication interface 110, identify at least one of a size or a resolution of the first area based on the content, and control the display 120 to display the content on the first area. For example, when the content has a resolution of 800×480, the processor 130 may identify the resolution of the first area as 800×480 and control the display 120 to display the content on the first area of 800×480.

When the size of the first area is adjusted according to a user command, the processor 130 may transmit information regarding the adjusted size to the electronic apparatus via the communication interface 110, and when content corresponding to the resized first area is received from the electronic apparatus, the processor 130 may control the display 120 to display the content corresponding to the resized first area on the resized first area. Here, the content corresponding to the resized first area may be content in which the resolution of the content has been changed, by the electronic apparatus, based on the information regarding the adjusted size. Further, the information regarding the adjusted size may include extended display identification data (EDID) for the adjusted size.

For example, when the size of the first area is adjusted from 800×480 to 1920×1080 according to a user command, the processor 130 may transmit information including the resolution 1920×1080 to the electronic apparatus via the communication interface 110. The electronic apparatus may then change the content to a resolution of 1920×1080 and provide the content with the changed resolution to the display apparatus 100. The processor 130 may control the display 120 to display the content of which resolution is changed on the first area of which size is changed to 1920×1080.

Through the above operation, the display apparatus 100 may display the content received from the electronic apparatus on the resized first area, and the first area may be used as a window. In particular, when the size of the first area is adjusted and information regarding the adjusted size is provided to the electronic apparatus as EDID, the electronic apparatus may identify the resized first area itself as a display. Since the electronic apparatus provides content corresponding to the resized first area, for example, when the size of the first area is reduced, first content with reduced resolution is provided to the display apparatus 100, thereby increasing transmission efficiency and reducing power consumption.

The electronic apparatus may provide content corresponding to the resized first area so that, for example, when the first area is reduced in size, the first content with reduced resolution may be provided to the display apparatus 100, thereby increasing transmission efficiency and reducing power consumption.

According to an embodiment, the display apparatus 100 may write the information regarding the adjusted size in the memory area where EDID is recorded and change (or toggle) the hot plug detect (HPD) signal from a low state to a high state so that the electronic apparatus reads the EDID information including the information regarding the adjusted size. However, hereinafter, for convenience of explanation, it is described that display apparatus 100 transmits information regarding the size to the electronic apparatus.

Here, the window may be an area that displays one task. In one or more embodiments, the window may be resizable by the user. In one or more embodiments, a window may be displayed overlapping with another window, and the content of a higher-priority window may be displayed in the overlapping area. Hereinafter, for convenience of explanation, the term “windows” is used interchangeably with the term “areas” with respect to portions of the display where content is displayed.

The processor 130 may receive information regarding size that can be provided by the electronic apparatus via the communication interface 110, and provide a graphical user interface (GUI) that guides at least one area corresponding to the size of the first area, which can be adjusted based on the information regarding the size while a user command is input.

For example, the processor 130 may request information regarding size that can be provided by the electronic apparatus from the electronic apparatus, and receive information from the electronic apparatus that the electronic apparatus can provide FHD resolution. In this case, the processor 130 may provide a GUI that guides the user through an area corresponding to the FHD resolution while a user command to touch and drag one of the edges of the first area is input. However, the present disclosure is not limited thereto, and the electronic apparatus may provide information that the electronic apparatus can provide a plurality of resolutions and in this case, the processor 130 may provide a plurality of GUIs corresponding to each of the plurality of resolutions. Alternatively, the processor 130 may provide only one GUI that is closest to the point of touch and drag from among the plurality of resolutions.

When the size of the first area is adjusted according to a user command, the processor 130 may identify whether the adjusted size corresponds to at least one area, and if the adjusted size does not correspond to the at least one area, readjust the adjusted area to one of the at least one area, and transmit information regarding the readjusted size to the electronic apparatus via the communication interface 110.

For example, when the first area of 800×480 is adjusted to 1600×960 according to a user command, the processor 130 may readjust the first area adjusted to 1600×960 to 1920×1080 based on information regarding the size that can be provided by the electronic apparatus, and transmit information including 1920×1080 to the electronic apparatus via the communication interface 110.

The processor 130 may control the display 120 to display other content received from other electronic apparatus via the communication interface 110 on a second area of the display 120. In other words, the processor 130 may display content received from the electronic apparatus on the first area and display other content received from other electronic apparatus on the second area. Through this operation, the processor 130 may provide a multi-window function. In addition, the processor 130 may provide content through a partial screen rather than a full screen, allowing multiple content to be provided on one screen, and user convenience can be enhanced as the sizes of areas can be freely adjusted.

However, the present disclosure is not limited thereto, and the processor 130 may receive content from three or more devices and display the received content through a plurality of windows.

The processor 130 may control the display 120 to display a task bar including an indicator corresponding to content and other indicator corresponding to other content. Here, the indicators may be referred to as icons, GUIs, and the like.

For example, the processor 130 may control the display 120 to display a task bar including an indicator corresponding to content and other indicator corresponding to other content on an area adjacent to a bottom edge of the display 120.

However, the present disclosure is not limited thereto, and the position of the task bar may change in various ways.

When a user command to select one of the indicator and the second indicator is received, the processor 130 may change the display state of the content corresponding to the selected indicator based on a priority of the content corresponding to the selected indicator. Here, if the display area of higher-priority content overlaps that of lower-priority content, higher-priority content may be displayed on the overlapping area. In addition, when a user's control command, for example, a control command such as a text input, is received, the processor 130 may execute the text input command with respect to higher-priority content. In addition, when a plurality of content received from each of a plurality of source devices is displayed, the processor 130 may distinctively display an area where the highest priority content is displayed and an area where the remaining content is displayed. For example, the processor 130 may display a highlight only on the border of the area where the highest priority content is displayed.

When the priority of the content corresponding to the selected indicator is lower than the priority of other content, the processor 130 may control the display 120 to display the content corresponding to the selected indicator on the area where the content corresponding to the selected indicator and other content overlap. Alternatively, when the priority of the content corresponding to the selected indicator is lower than the priority of other content and there is no overlapping area, the processor 130 may raise the priority of the content corresponding to the selected indicator over the priority of other content.

Alternatively, when the priority of the content corresponding to the selected indicator is higher than the priority of the remaining content, the processor 130 may control the display 120 to display the content corresponding to the selected indicator through the entire area of the display 120. When the priority of the content corresponding to the selected indicator is higher than the priority of other content, the processor 130 may transmit information regarding the entire area to the device that provides the content corresponding to the selected indicator via the communication interface 110. In this case, the electronic apparatus may change the content to a resolution corresponding to the entire area, and provide the content with the changed resolution to the display apparatus 100. The processor 130 may control the display 120 to display the content with the changed resolution on the entire area.

In the above description, the processor 130 identifies the first area based on content, but the present disclosure is not limited thereto. For example, the processor 130 may receive content from the electronic apparatus via the communication interface 110, and identify at least one of the size or resolution of the first area based on the type of content.

Alternatively, the processor 130 may identify the first area based on the connection history of the electronic apparatus. For example, the processor 130 may be connected to the electronic apparatus at a first point in time and display content on a partial area of the display 120 and subsequently, when being connected again to the electronic apparatus at a second point in time after being disconnected, may identify the partial area where the content was displayed at the time of disconnection as the first area.

Alternatively, the processor 130 may identify the first area based on the type of connection of the electronic apparatus to the display apparatus 100. For example, when the electronic apparatus is connected to the display apparatus 100 via an HDMI cable, the processor 130 may identify an area of a first size as the first area, and when the electronic apparatus is connected to the display apparatus 100 via Bluetooth, the processor 130 may identify an area of a second size as the first area.

Alternatively, the processor 130 may identify the first area based on the number of pieces of content that the display apparatus 100 is displaying when the electronic apparatus is connected to the display apparatus 100. For example, the display apparatus 100 displays no content when the electronic apparatus is connected to the display apparatus 100, the processor 130 may identify the entire area as the first area, and when the display apparatus 100 displays three pieces of content when the electronic apparatus is connected to the display apparatus 100, the processor 130 may identify the first area based on the size of the remaining areas excluding the area where the three pieces of content are displayed.

When it is identified that the electronic apparatus is connected to the display apparatus 100 via the communication interface 110, the processor 130 may transmit information regarding the size of the first area to the electronic apparatus via the communication interface 110, and receive content corresponding to the first area from the electronic apparatus via the communication interface 110. Here, the content corresponding to the first area may be content where the resolution of the original content is changed by the electronic apparatus based on the information regarding the size of the first area.

While the size of the first area is being adjusted, the processor 130 may control the display 120 to display a preset image on the first area of which size is being adjusted. For example, while a user command to touch and drag one of the edges of the first area is input, the processor 130 may control the display 120 to display an image including a guide message saying “screen size is being adjusted” on the first area of which size is being adjusted.

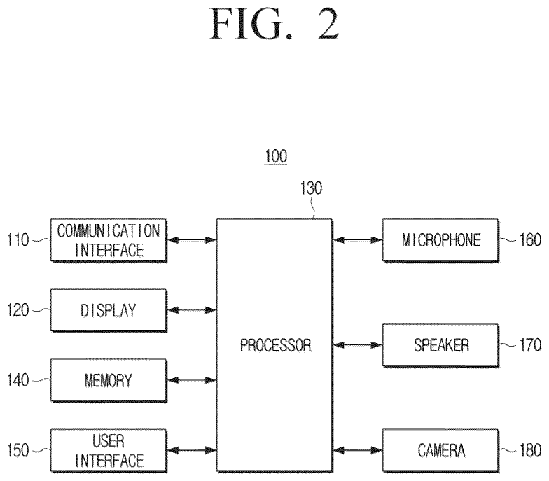

FIG. 2 is a block diagram illustrating detailed configuration of the display apparatus 100 according to an embodiment. The display apparatus 100 may include the communication interface 110, the display 120, and the processor 130. Referring to FIG. 2, the display apparatus 100 may further include a memory 140, a user interface 150, a microphone 160, a speaker 170, and a camera 180. Detailed description will be omitted for some of the components shown in FIG. 2, which overlap with those shown in FIG. 1.

The memory 140 may refer to hardware that stores information, such as data, in electrical or magnetic form for access by the processor 130 or the like. To this end, the memory 140 may be implemented as at least one of the following hardware: non-volatile memory, volatile memory, flash memory, hard disk drive (HDD) or solid state drive (SSD), RAM, ROM, etc.

The memory 140 may store at least one instruction required for the operation of the display apparatus 100 or the processor 130. Here, the instruction is a code unit that directs the operation of the display apparatus 100 or processor 130, and may be written in a machine language that can be understood by a computer. Alternatively, the memory 140 may store EDID and DPCD regarding the display 120.

The memory 140 may store data, which is information in bits or bytes that may represent characters, numbers, images, and the like. For example, the memory 140 may store a multi-window driving module, an EDID module, a task bar module, a GUI module, etc.

The memory 140 is accessed by the processor 130, and reading/writing/modifying/deleting/updating instructions, a set of instructions, or data may be performed by the processor 130.

The user interface 150 may be implemented as a button, a touch pad, a mouse, a keyboard, etc., or may be implemented as a touch screen that can also perform a display function and a manipulation input function. Here, the button may be a various types of buttons such as a mechanical button, a touch pad, a wheel, etc. formed in any arbitrary area of the exterior of the main body of the display apparatus 100, such as the front, side, or back.

The microphone 160 is configured to receive sound input and convert it into an audio signal. The microphone 160 is electrically connected to the processor 130, and may receive sound under the control of the processor 130.

For example, the microphone 1860 may be integrally formed in the direction of the top, front, side, etc. of the display apparatus 100. Alternatively, the microphone 160 may be formed on a remote controller, etc. that is separate from the display apparatus 100. In this case, the remote controller may receive sound through the microphone 160, and provide the received sound to the display apparatus 100.

The microphone 160 may include various components such as a microphone that collects analog sound, an amplification circuit that amplifies the collected sound, an A/D conversion circuit that samples the amplified sound and converts it into a digital signal, a filter circuit that removes noise components from the converted digital signal, etc.

The microphone 160 may be implemented in the form of a sound sensor, and may be any configuration capable of collecting sound.

The processor 130 may also receive user commands via the microphone 160.

The speaker 170 is configured to output various notification sounds or voice messages as well as various audio data processed by the processor 130.

The processor 130 may also provide various messages to the user via the speaker 170.

The camera 180 includes a lens, a shutter, an aperture, a solid-state imaging device, an analog front end (AFE), and a timing generator (TG). The shutter controls the time when light reflected from a subject enters the camera 180, and the aperture controls the amount of light entering the lens by mechanically increasing or decreasing the size of the opening through which the light enters. When the light reflected from the subject is accumulated as a photoelectric charge, the solid-state imaging device outputs an image by the photoelectric charge as an electrical signal. The TG outputs a timing signal to read out the pixel data of the solid-state imaging device, and the AFE samples and digitizes the electrical signal output from the solid-state imaging device.

As described above, the display apparatus 100 may provide a multi-window function by providing EDID corresponding to individual windows to the source device, thereby facilitating task switching and increasing the user's degree of freedom.

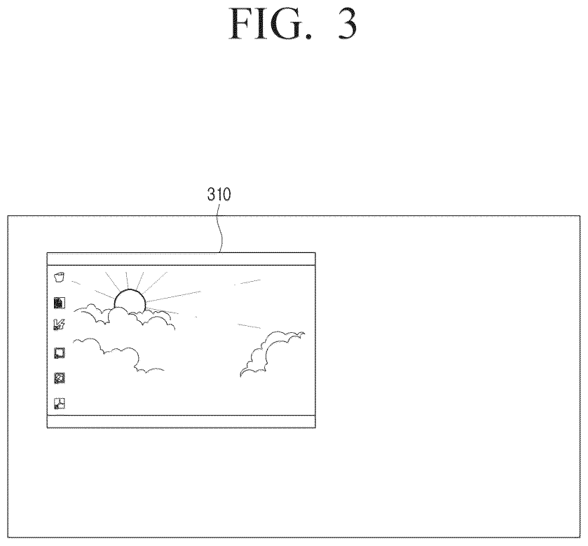

Hereinafter, the operation of the display apparatus 100 will be described in greater detail with reference to FIGS. 3 to 17. For convenience of explanation, individual embodiments are described in FIGS. 3 to 17. However, the individual embodiments of FIGS. 3 to 17 may be implemented in any combination.

FIG. 3 is a view illustrating a screen on which a window is displayed according to an embodiment.

When it is identified that the electronic apparatus is connected to the display apparatus via the communication interface 110, the processor 130 may identify the first area, and transmit information regarding the size of the first area to the electronic apparatus via the communication interface 110.

For example, when it is identified that the electronic apparatus is connected to the display apparatus via the communication interface 110, the processor 130 may identify the first area based on at least one of a connection history of the electronic apparatus or a communication standard between the display apparatus 100 and the electronic apparatus. Alternatively, when it is identified that the electronic apparatus is connected to the display apparatus via the communication interface 110, the processor 130 may identify the first area based on at least one of the number, size, or position of windows which are currently displayed.

The electronic apparatus may obtain content where the resolution of the original content is changed based on information regarding the size of the first area, and provide the obtained content to the display apparatus 100.

However, the present disclosure is not limited thereto, and content may be received immediately without an identification operation of the first area. In this case, the electronic apparatus may provide the original content to the display apparatus 100, and the processor 130 may identify the first area based on the type of the original content and control the communication interface 110 to transmit information regarding the size of the first area to the electronic apparatus. The electronic apparatus may obtain content where the resolution of the original content is changed based on the information regarding the size of the first area, and provide the obtained content to the display apparatus 100.

The processor 130 may display content received from the electronic apparatus on the first area. Here, the first area may be the entire area of the display 120, but may also be a portion of the display 120. For example, as shown in FIG. 3, the processor 130 may display the content received from the electronic apparatus on a first area 310, which is a portion of the display 120. In other words, the processor 130 may display the content received from the electronic apparatus on the first area as a window.

The processor 130 may obtain information regarding the size that can be provided by the electronic apparatus before transmitting the information regarding the size of the first area to the electronic apparatus, and identify the first area based on the obtained information. Alternatively, when the electronic apparatus is not capable of changing the resolution or ratio, the processor 130 may identify the area corresponding to the received content as the first area.

While FIG. 3 describes that the content received from the electronic apparatus is displayed on the first area, the present disclosure is not limited thereto. For example, the first area may display a screen of an application installed on the display apparatus 100. For example, the processor 130 may identify whether the source to be executed in response to a user command is content received from the electronic apparatus or an application installed on the display apparatus 100. When the content is executed, the processor 130 may obtain information regarding the size that can be provided by the electronic apparatus and identify the first area based on the obtained information, and when the application is executed, the processor 130 may identify the first area based on the ratio/size recommended by the application.

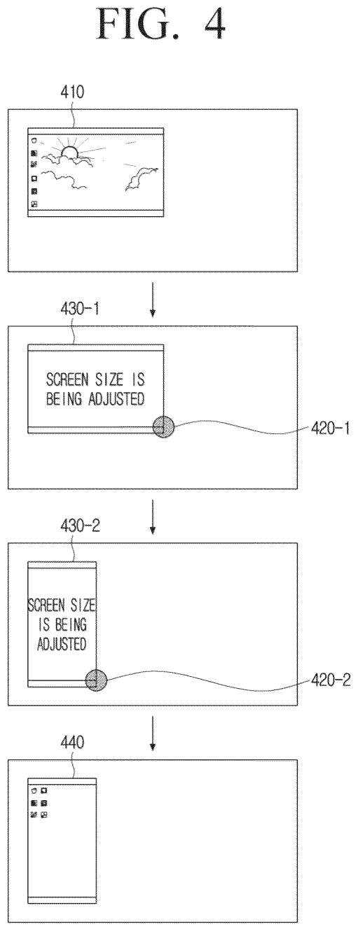

FIG. 4 is a view provided to explain a size change of a window according to an embodiment.

The processor 130 may display content received from the electronic apparatus on the first area, such as 410 in FIG. 4.

The processor 130 may adjust the size of the first area according to a user command to touch and drag from point 420-1 to point 420-2. While the size is being adjusted, the processor 130 may provide a message informing that the “screen size is being adjusted.” The message informing that the “screen size is being adjusted” may be displayed as 430-1 and changed to 430-2 as the screen is resized.

When the touch is released at point 420-2, the processor 130 may adjust the size of the first area and transmit information regarding the adjusted size to the electronic apparatus via the communication interface 110, and when content corresponding to the resized first area is received from the electronic apparatus, may display the content corresponding to the resized first area on the resized first area. Here, the electronic apparatus may change the resolution of the content or the layout of content elements included in the content based on the information regarding the adjusted size. For example, the content may include indicators, images, videos, text boxes, and the like as content elements, and the electronic apparatus may change the position, size, etc. of each content element based on the information regarding the adjusted size.

However, the present disclosure is not limited thereto, and when the size of the first area is adjusted according to a user command, the processor 130 may identify the type of adjustment. For example, when the size of the first area is changed while the aspect ratio is maintained, the processor 130 may transmit information regarding the adjusted size to the electronic apparatus. Alternatively, when the size of the first area is changed without maintaining the aspect ratio, the processor 130 may transmit information regarding the adjusted size and a signal requesting a change in the layout of content elements included in the content to the electronic apparatus.

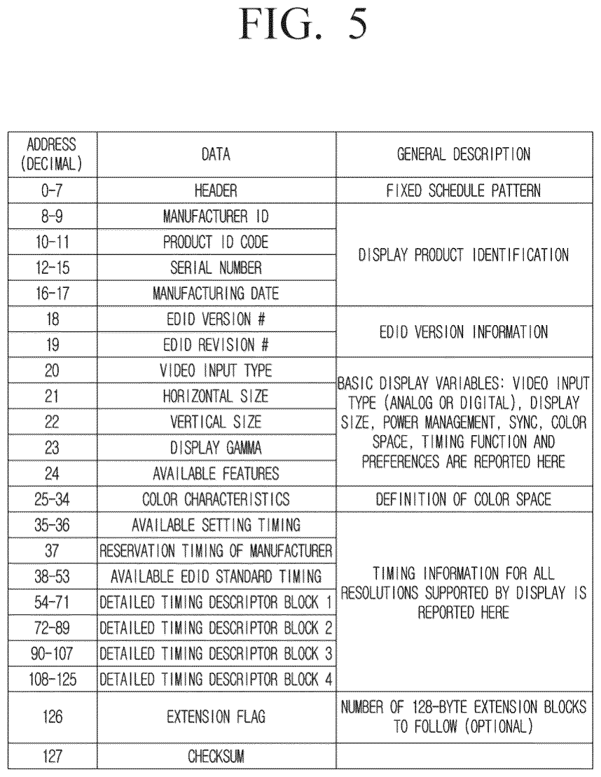

FIG. 5 is a view provided to explain information regarding an adjusted size according to an embodiment.

The information regarding the adjusted size may include EDID for the adjusted size. For example, the information regarding the adjusted size may include information regarding the horizontal size, vertical size, display gamma, available features, color characteristics, and the like, as shown in FIG. 5.

In this case, the electronic apparatus may identify that the EDID is received from the display apparatus 100, perform image-processing on the content to correspond to the EDID, and provide the image-processed content to the display apparatus 100.

In other words, the display apparatus 100 provides EDID corresponding to the first area to the electronic apparatus, thereby operating as if the first area is a single display apparatus.

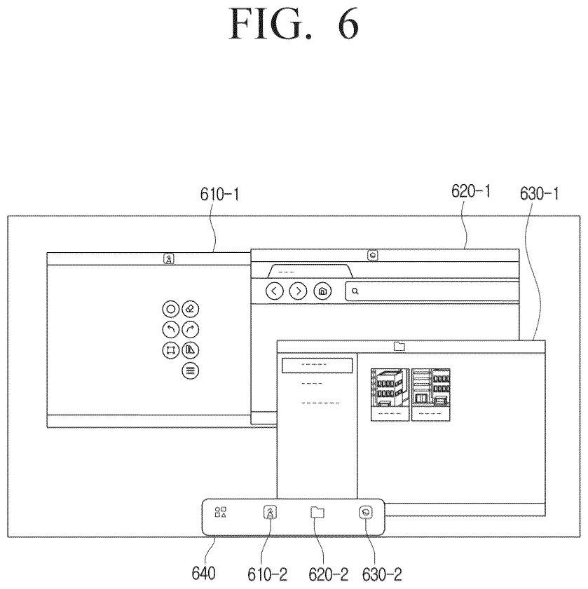

FIG. 6 is a view provided to explain a multi-window and a task bar according to an embodiment.

The processor 130 may display a plurality of content on each of a plurality of areas. For example, the processor 130 may display first content on a first area 610-1, second content on a second area 620-1, and third content on a third area 630-1, as shown in FIG. 6.

Here, the plurality of content may be received from a plurality of electronic apparatuses, or may be screens of a plurality of applications. Alternatively, some of the plurality of content may be received from at least one electronic apparatus and the remaining content may be screens of at least one application.

The processor 130 may display a task bar that includes a plurality of indicators corresponding to the plurality of contents, respectively. For example, the processor 130 may display a task bar 640 that includes a first indicator 610-2 corresponding to first content, a second indicator 620-2 corresponding to second content, and a third indicator 630-2 corresponding to third content, as shown in FIG. 6.

In FIG. 6, the task bar is shown displayed at the bottom for convenience of explanation, but is not limited thereto, and the task bar may be displayed in various locations. For example, the processor 130 may display the task bar at the top of the display 120. Alternatively, the processor 130 may identify an area in which the task bar is to be displayed based on the position of at least one window. Alternatively, the processor 130 may identify an area in which the task bar is to be displayed based on the number of the at least one window. For example, as shown in FIG. 6, when the number of the at least one window is equal to or greater than a preset number, the processor 130 may display the task bar at the bottom, and when the number of the at least one window is less than the preset number, may display the task bar on the left or right. When the task bar is displayed on the left or right, a plurality of indicators may be arranged in an upward or downward direction.

If there is no user command for a preset period of time, the processor 130 may not display the task bar.

When a user command is input while the task bar is not displayed, the processor 130 may display the task bar. For example, the processor 130 may display the task bar in response to a swipe input from the user. Alternatively, when a signal corresponding to a home key of a remote controller is received from the remote controller, the processor 130 may display the task bar. Alternatively, when a pointer is positioned at an edge of the display 120, the processor 130 may display the task bar. For example, when the pointer is positioned on the left edge of the display 120, the processor 130 may display the task bar on the left side of the display 120, and when the pointer is positioned on the right edge of the display 120, the processor 130 may display the task bar on the right side of the display 120.

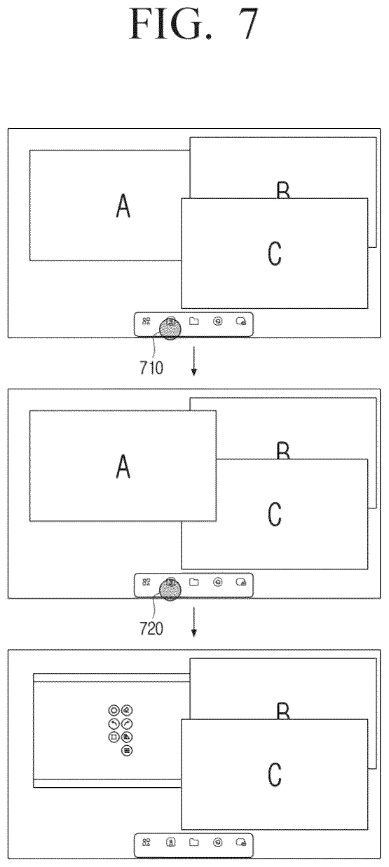

FIG. 7 is a view provided to explain an operation in response to a manipulation of a task bar according to an embodiment.

The processor 130 may display a plurality of windows based on priority. For example, processor 130 may display screen A, screen B, and screen C based on priority, as shown at the top of FIG. 7. Here, screen S may be displayed on the area where screen C with the highest priority is overlapped with screen A and screen B. Screen B may be displayed on the arear where screen B with the second highest priority is overlapped with screen A.

When an indicator 710 corresponding to screen A which is not the highest priority is manipulated on the task bar, the processor 130 may raise the priority of screen A over screen B and screen C, such that screen A is displayed on the area where screen A is overlapped with screen B and screen C.

When an indicator 720 corresponding to screen A which is the highest priority is manipulated on the task bar, the processor 130 may not display screen A. As a result, C becomes the highest priority, and a screen that was not seen due to lower priority than screen A may be displayed.

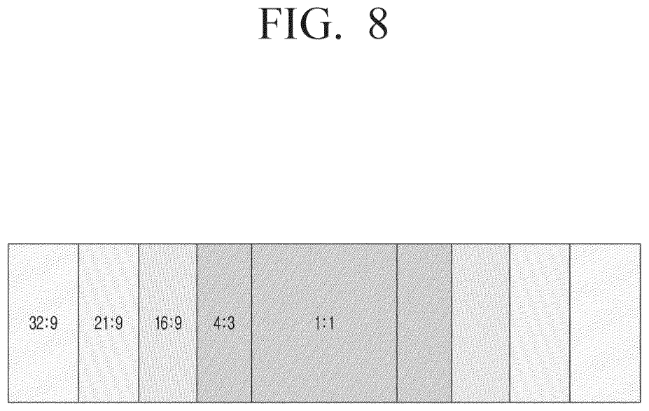

FIG. 8 is a view provided to explain information regarding a size that can be provided by an electronic apparatus according to an embodiment.

The processor 130 may receive information regarding a size that can be provided by the electronic apparatus from the electronic apparatus. For example, the processor 130 may receive information that the electronic apparatus is capable of adjusting the ratio, such as 1:1, 4:3, 16:9, 21:9, 32:9, as shown in FIG. 8.

However, the present disclosure is not limited thereto, and the processor 130 may receive information regarding the resolution that can be provided by the electronic apparatus. Alternatively, the processor 130 may receive a range of sizes or resolutions that can be provided by the electronic apparatus. Alternatively, the processor 130 may receive information that the electronic apparatus is incapable of adjusting the size.

The processor 130 may provide a GUI that guides at least one area corresponding to the size of the first area that is adjustable based on information regarding the size that can be provided by the electronic apparatus.

Alternatively, when the electronic apparatus is incapable of adjusting the size, the processor 130 may not provide a GUI. In addition, when the electronic apparatus is incapable of adjusting the size, the processor 130 may not adjust the size of the first area even if the user touches and drags an edge of the first area.

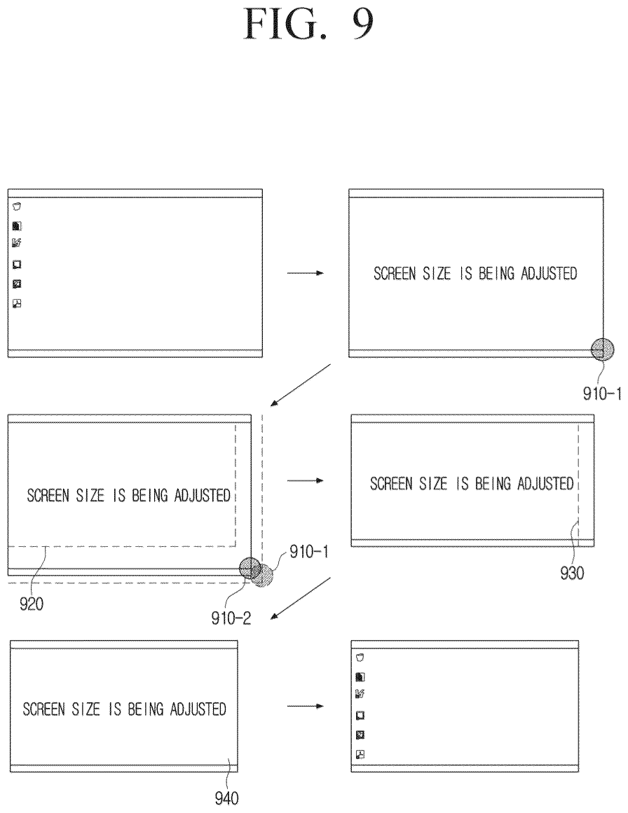

FIG. 9 is a view provided to explain an operation of adjusting a size of a window according to an embodiment.

The processor 130 may display content received from the electronic apparatus on the first area as shown in the upper left corner of FIG. 9, and when a user command to touch point 910-1 is received as shown in the upper right corner of FIG. 9, may display an image that includes a guide message “screen size is being adjusted” on the first area.

The processor 130 may provide a GUI, such as 920, in response to a user command to touch point 910-1. The GUI, such as 920, may be a GUI that guides an area corresponding to the size of the first area that is adjustable based on information regarding the size that can be provided by the electronic apparatus. Here, the processor 130 may provide a GUI that guides an area of a size most similar to the size of the first area. However, the present disclosure is not limited thereto, and the processor 130 may display a plurality of GUIs that guide areas corresponding to a plurality of sizes of the first area adjustable based on information regarding the size that can be provided by the electronic apparatus.

When a user command to touch point 910-1, drag to 910-2 and release the touch is received, the processor 130 may reduce the first area. Here, the reduced first area may not match a GUI such as 920. For example, the first area may have the same vertical length as the vertical length of a GUI such as 920, but have a different horizontal length, such that a GUI may be displayed as shown in 930.

The processor 130 may reduce the first area again as shown in 940 so as to correspond to the GUI as shown in 930. In this case, the horizontal area of the first area may be reduced.

When the adjustment is completed, the processor 130 may transmit information regarding the adjusted size to the electronic apparatus, and when content corresponding to the resized first area is received, may display the content corresponding to the resized first area on the resized first area.

While the size of the first area is being adjusted, the processor 130 may display a preset image on the first image of which size is being adjusted. For example, even if the touch is released, when the first area is additionally adjusted, the processor 130 may display the preset image on the first area of which size is being adjusted until the adjustment is completed.

The processor (130) may adjust the size of the preset image as the size of the first area is adjusted, and display the preset image whose size has been adjusted in the first area whose size has been adjusted.

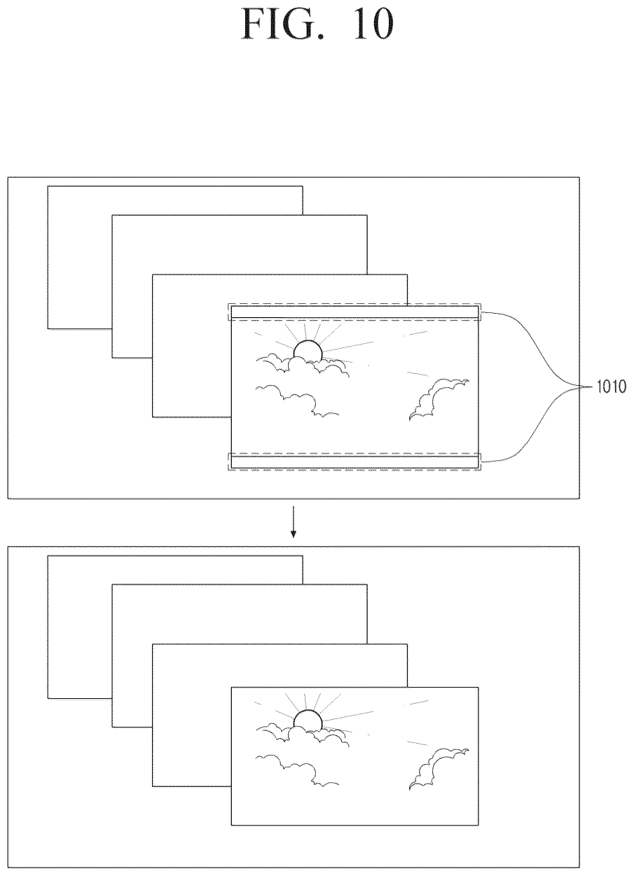

FIG. 10 is a view provided to explain an operation of displaying a decorator according to an embodiment.

The processor 130 may add a decorator to a window with the highest priority. For example, as shown at the top of FIG. 10, the processor 130 may display a plurality of windows, and add a decorator 1010 to the top and bottom of the highest-priority window from among the plurality of windows. Here, the decorator may be a UI to assist the user in identifying the highest-priority window, and may be represented in various ways. As the decorator is displayed only on the highest-priority window, there is an effect of reducing resources.

When there is no user command for a preset period of time after the decorator is displayed, the processor 130 may not display a decorator.

When a user command is input while a decorator is not displayed, the processor 130 may display the decorator. For example, when a user command, such as a mouse movement, is input while the decorator is not displayed, the processor 130 may display the decorator on the window in which the decorator was added. Alternatively, when a user command to select a window that did not have a decorator is input while the decorator is not displayed, the processor 130 may change the priority of the window that did not have a decorator to the highest priority and add the decorator.

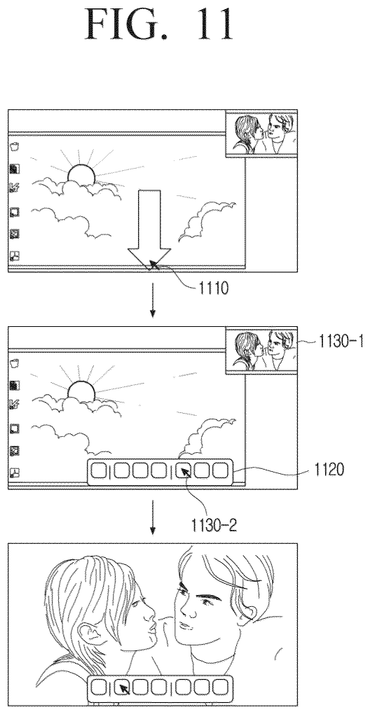

FIG. 11 is a view provided to explain an operation in response to a manipulation of a task bar according to an embodiment.

When a pointer is positioned at an edge of the display 120, the processor 130 may display the task bar. For example, when the pointer is positioned at the bottom edge of the display 120, as shown at the top of FIG. 11, the processor 130 may display a task bar 1120 at the bottom of the display 120, as shown in the center of FIG. 11.

According to an embodiment, as shown at the bottom of FIG. 11, when a first indicator 1130-2 corresponding to a first window 1130-1 with the highest priority is selected while the task bar 1120 is displayed at the bottom of the display 120, the processor 130 may display the first window 1130-1 on full screen.

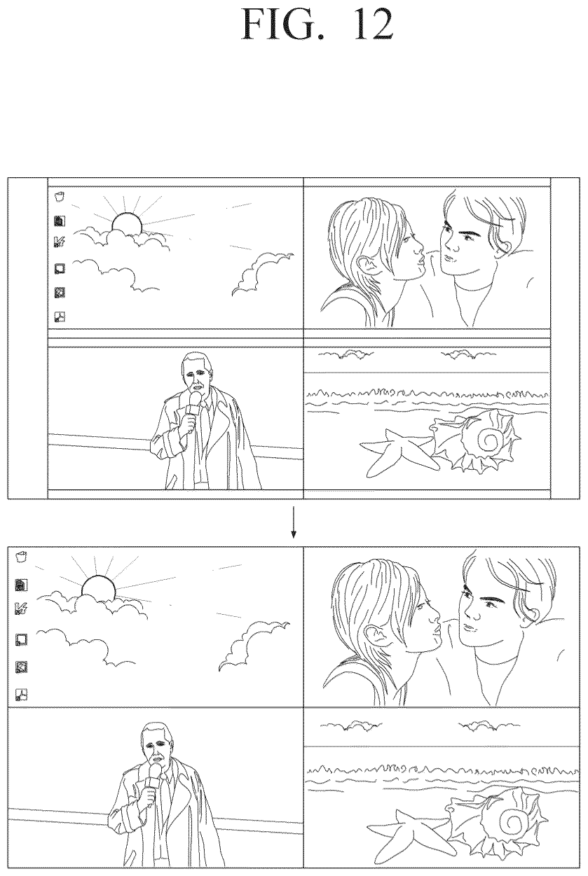

FIG. 12 is a view provided to explain a mode for arranging a plurality of windows according to an embodiment.

As shown at the top of FIG. 12, the processor 130 may provide a first mode in which a plurality of windows are automatically arranged and a decorator is added to each of the plurality of windows. Here, the processor 130 may change the plurality of windows to have the same size, and automatically arrange the resized plurality of windows so that they do not overlap each other.

Alternatively, as shown at the bottom of FIG. 12, the processor 130 may provide a second mode in which a plurality of windows are automatically arranged. Here, the processor 130 may change the plurality of windows to have the same size, and automatically arrange the resized plurality of windows so that they do not overlap each other. However, since a decorator is not provided, resources can be saved.

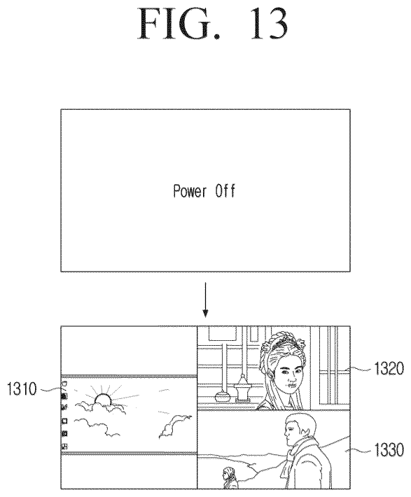

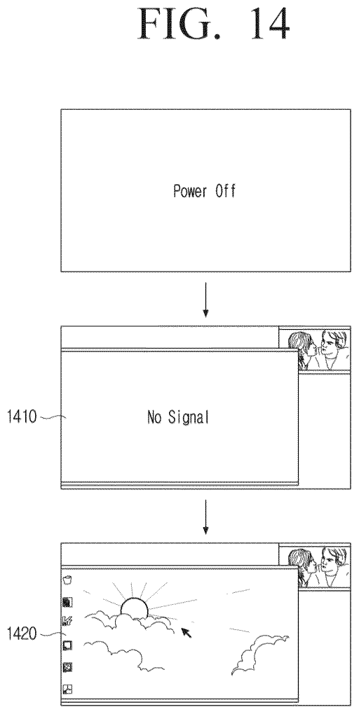

FIGS. 13 and 14 are views provided to explain a case where the display apparatus 100 is turned on according to an embodiment.

When the display apparatus 100 is turned on, the processor 130 may display at least one content based on a state before the display apparatus 100 is turned off.

For example, as shown in FIG. 13, when the display apparatus 100 is turned on, the processor 130 may display first content, second content, and third content on a first area 1310, a second area 1320, and a third area 1330, respectively, based on the state before the display apparatus 100 is turned off. Here, the first content, the second content, and the third content may be the content that was being displayed on the first area 1310, the second area 1320, and the third area 1330, respectively, before the display apparatus 100 is turned off.

When the display apparatus 100 is turned on, the processor 130 may determine an operation of each window based on an operation state of at least one window before the display apparatus 100 is turned off. For example, the processor 130 may store playback information for the second content and the third content, which are videos, before the display apparatus 100 is turned off, and when the display apparatus 100 is turned on, may play at least one of the second content or the third content based on the stored playback information.

When the display apparatus 100 is turned on, the processor 130 may display at least one content based on a state of the display apparatus 100 before the display apparatus 100 is turned off. However, when no content is provided from the electronic apparatus, the processor 130 may transmit a signal to wake up the electronic apparatus to the electronic apparatus.

For example, as shown in FIG. 14, when the display apparatus 100 is turned on, the processor 130 may display a plurality of content on each of a plurality of areas based on a state before the display apparatus 100 is turned off. However, while the display apparatus 100 is turned off, the electronic apparatus providing the content displayed on the first area may enter a standby mode. In this case, even when the display apparatus 100 is turned on, the electronic apparatus may not provide content to the display apparatus 100, and the first area may display an image including the phrase “No Signal”. Accordingly, the processor 130 may transmit a signal to wake up the electronic apparatus to the electronic apparatus in order to be provided with the content displayed on a first area 1410.

The electronic apparatus may be woken up based on a signal to wake up the electronic apparatus, and provide content to the display apparatus 100. The processor 130 may display the content 1420 received from the electronic apparatus on the first area.

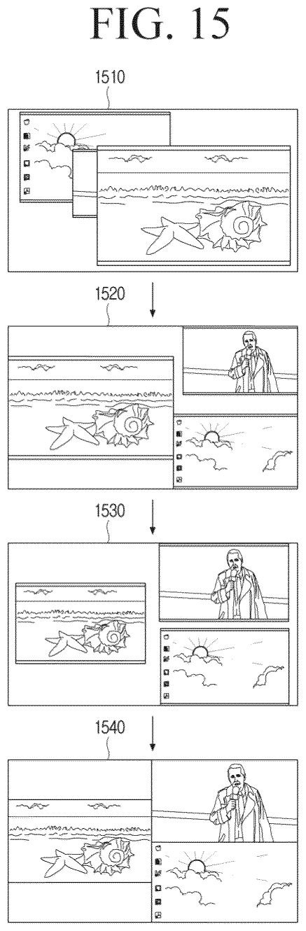

FIG. 15 is a view provided to explain a method of automatically arranging a plurality of windows according to an embodiment.

The display apparatus 100 may provide a plurality of modes for displaying a plurality of windows.

For example, the processor 130 may provide a first mode 1510 in which a plurality of windows are displayed in an overlapping manner. In this case, each of the plurality of windows is given a priority, and when the plurality of windows are overlapped, a window with the highest priority may be displayed on the overlapping area.

Alternatively, the processor 130 may provide a second mode 1520 in which the plurality of windows are resized and displayed so that there are no overlapping areas, while maintaining a ratio of screen area between the plurality of windows. In this case, the processor 130 may change the position and size of the plurality of windows to display the plurality of windows at the largest possible size.

Alternatively, the processor 130 may provide a third mode 1530 in which the plurality of windows are all changed to have the same size and displayed. In this case, the processor 130 may change the position and size of the plurality of windows to display the plurality of windows at the largest possible size.

Alternatively, the processor 130 may provide a fourth mode 1540 in which each of the plurality of windows is displayed at its maximum size while the plurality of windows are not overlapped. In this case, the processor 130 may not maintain a ratio of screen area between the plurality of windows. In addition, the plurality of windows may all be of different sizes, and the processor 130 may display a higher-priority window from among the plurality of windows at a relatively larger size.

The processor 130 may display a plurality of windows in one of a plurality of modes based on a user command.

However, the present disclosure is not limited thereto, and the processor 130 may display a plurality of windows in one of a plurality of modes based on the type of the plurality of content corresponding to each of the plurality of windows. For example, when one of the plurality of content is a video and the other content is a web browser, the processor 130 may identify the video as the highest priority and display the plurality of windows in the fourth mode.

Alternatively, when new content is displayed while a plurality of windows are displayed in one of a plurality of modes, the processor 130 may change the mode based on the new content.

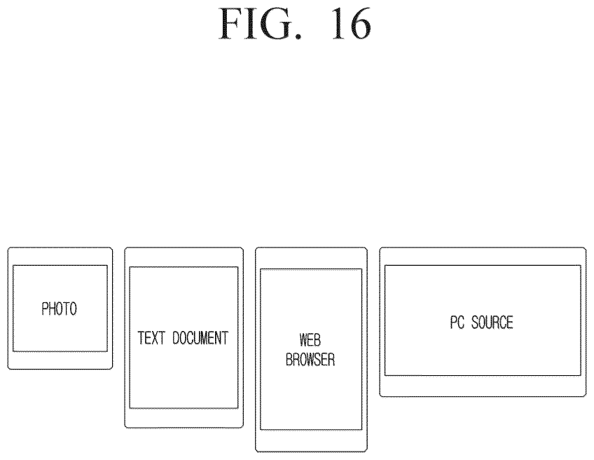

FIG. 16 is a view provided to explain a method of identifying a first area in response to a type of content according to an embodiment.

The processor 130 may identify the first area based on the type of content provided from the electronic apparatus. For example, the processor 130 may identify the first area differently based on whether the type of content is a photo, a text document, a web browser, or a PC source, as shown in FIG. 16.

However, the present disclosure is not limited thereto, and the processor 130 may also identify the aspect ratio of the first area based on the type of content provided from the electronic apparatus. In other words, the processor 130 may vary the size of the first area while maintaining only the aspect ratio of the first area.

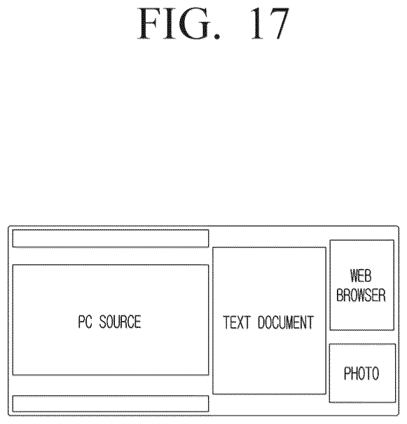

FIG. 17 is a view provided to explain a method of disposing areas by type of content according to an embodiment.

The processor 130 may identify a priority for each content based on the type of content, and may display a plurality of windows based on the priority.

For example, the processor 130 may identify a priority in the order of PC source, text document, web browser, and photo, as shown in FIG. 17, and allocate a larger area in the descending order of priority. Accordingly, in FIG. 17, the PC source may be displayed in the largest area.

However, the present disclosure is not limited thereto, and the processor 130 may also identify a priority of content based on the user's usage pattern and display a plurality of windows based on the priority.

For example, the processor 130 may accumulate and store usage time for each type of content and prioritize the content in the descending order of usage time.

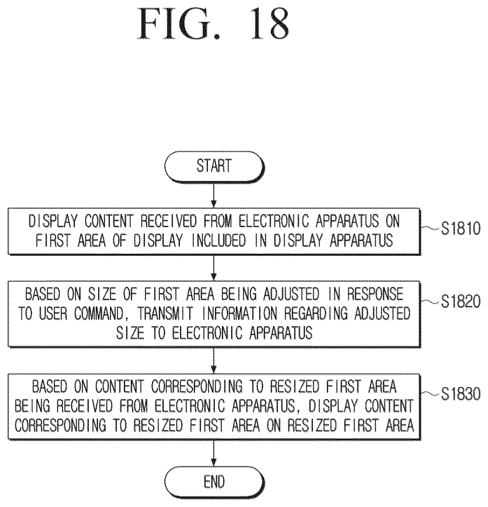

FIG. 18 is a flowchart provided to explain a controlling method of a display apparatus according to an embodiment.

First, the content received from the electronic apparatus is displayed on the first area of the display included in the display apparatus (S1810). When the size of the first area is adjusted according to a user command, information regarding the adjusted size is transmitted to the electronic apparatus (S1820). Subsequently, when content corresponding to the resized first area is received from the electronic apparatus, the content corresponding to the resized first area is displayed on the resized first area (S1830).

In addition, the content corresponding to the resized first area may be content in which the resolution of the content is changed by the electronic apparatus, based on information regarding the resized area.

The method may further include receiving information from the electronic apparatus about the size that can be provided by the electronic apparatus, and providing a GUI to guide at least one area corresponding to the size of the first area adjustable based on the information regarding the size while a user command is input.

In addition, the method may further include, when the size of the first area is adjusted according to the user command, identifying whether the adjusted size corresponds to the at least one area, and when the adjusted size does not correspond to the at least one area, and readjusting the adjusted size to one of the at least one area, and the transmitting (S1820) may include transmitting information regarding the readjusted size to the electronic apparatus.

The method may further include displaying other content received from other electronic apparatus on the second area of the display and displaying a task bar including an indicator corresponding to the content and another indicator corresponding to the other content.

The method may further include, when a user command to select one of the indicator and the second indicator is received, changing a display state of the content corresponding to the selected indicator based on a priority of the content corresponding to the selected indicator.

The changing may include, when the content corresponding to the selected indicator has a lower priority than the other content, displaying the content corresponding to the selected indicator on the area where the content corresponding to the selected indicator and the other content overlap, and when the content corresponding to the selected indicator has a higher priority than the other content, displaying the content corresponding to the selected indicator over the entire area of the display.

In addition, the changing may include, when the content corresponding to the selected indicator has a higher priority than the other content, transmitting information regarding the entire area to the device providing the content corresponding to the selected indicator.

The method may further include receiving content from the electronic apparatus and identifying at least one of a size or resolution of the first area based on the type of content.

The method may further include, when it is identified that the electronic apparatus is connected to the display apparatus, transmitting information regarding the size of the first area to the electronic apparatus and receiving content corresponding to the first area from the electronic apparatus, and the content corresponding to the first area may be content in which the resolution of the original content is changed by the electronic apparatus, based on the information regarding the size of the first area.

The information regarding the adjusted size may include extended display identification data (EDID) for the adjusted size.

The method may further include displaying a preset image on the first area of which size is being adjusted while the size of the first area is being adjusted.

In accordance with various embodiments, the display apparatus may provide a multi-window function by providing EDID corresponding to individual windows to the source device, thereby facilitating task switching and increasing the user's degree of freedom.

According to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic apparatus according to the aforementioned embodiments (e.g.: electronic apparatus (A)). In case an instruction is executed by a processor, the processor may perform a function corresponding to the instruction by itself, or by using other components under its control. An instruction may include a code that is generated or executed by a compiler or an interpreter. The machine-readable storage medium may be provided in the form of a non-transitory storage medium. Here, the term “non-transitory” means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in the form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

In addition, according to an embodiment, the above-described various embodiments may be implemented in a recording medium that can be read by a computer or a similar device using software, hardware, or a combination thereof. In some cases, embodiments described herein may be implemented by a processor itself. According to software implementation, embodiments such as procedures and functions described in this specification may be implemented as separate software. Each software may perform one or more functions and operations described in this disclosure.

Computer instructions for performing processing operations of devices according to the above-described various embodiments may be stored in a non-transitory computer-readable medium. When being executed by a processor of a specific device, the computer instructions stored in such a non-transitory computer-readable medium allows the specific device to perform processing operations in the device according to the above-described various embodiments. The non-transitory computer-readable medium refers to a medium that stores data semi-permanently and can be read by a device, rather than a medium that stores data for a short period of time, such as registers, caches, and memories. Specific examples of the non-transitory computer-readable medium may include CD, DVD, hard disk, Blu-ray disk, USB, memory card, ROM, etc.

In addition, the components (for example, modules or programs) according to various embodiments described above may include a single entity or a plurality of entities, and some of the corresponding sub-components described above may be omitted or other sub- components may be further included in the various embodiments. Alternatively or additionally, some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, or at least some of the operations may be performed in a different order or be omitted, or other operations may be added.

Although certain embodiments of the present disclosure have been shown and described above, the disclosure is not limited to the specific embodiments described above, and various modifications may be made by one of ordinary skill in the art without departing from the spirit of the disclosure as claimed in the claims, and such modifications are not to be understood in isolation from the technical ideas or prospect of the disclosure.

What is claimed is:

1. A display apparatus comprising:
a communication interface;
a display;
at least one memory storing one or more instructions; and
at least one processor connected to at least one memory, the communication interface and the display,
wherein the at least one processor is configured to execute the one or more instructions, and wherein the one or more instructions, when executed by the at least one processor, cause the display apparatus to:
control the display to display content received from an electronic apparatus through the communication interface on a first area of the display,
based on a size of the first area being adjusted according to a user command, transmit information regarding the adjusted size to the electronic apparatus through the communication interface, and
based on receiving additional content corresponding to the resized first area from the electronic apparatus, control the display to display the additional content on the resized first area.

2. The display apparatus of claim 1, wherein a resolution of the additional content is based on the information regarding the adjusted size.

3. The display apparatus of claim 1, wherein the one or more instructions, when executed by the at least one processor, further cause the display apparatus to:
based on the user command being input, provide a GUI for guiding adjustment of the size of the first area based on information received from the electronic apparatus, through the communication interface, regarding one or more available area sizes.

4. The display apparatus of claim 3, wherein the one or more instructions, when executed by the at least one processor, further cause the display apparatus to:
based on the size of the first area being adjusted according to the user command, identify whether the adjusted size corresponds to one of the one or more available area sizes,
based on the adjusted size not corresponding to one of the one or more available area sizes, readjust the adjusted size to one of the one or more available area sizes, and
transmit information regarding the readjusted size to the electronic apparatus through the communication interface.

5. The display apparatus of claim 1, wherein the one or more instructions, when executed by the at least one processor, further cause the display apparatus to:
control the display to display second content received from a second electronic apparatus through the communication interface on a second area of the display, and
control the display to display a task bar comprising an indicator corresponding to the content and a second indicator corresponding to the second content.

6. The display apparatus of claim 5, wherein the one or more instructions, when executed by the at least one processor, further cause the display apparatus to:
based on receiving a user command to select the indicator or the second indicator, change a display state of content corresponding to the selected indicator based on a priority of the content corresponding to the selected indicator.

7. The display apparatus of claim 6, wherein the one or more instructions, when executed by the at least one processor, further cause the display apparatus to:
based on the priority of the content corresponding to the selected indicator being lower than a priority of remaining content, control the display to display an area where the content corresponding to the selected indicator and the other content overlap, and
based on the priority of the content corresponding to the selected indicator being higher than a priority of the remaining content, control the display to display the content corresponding to the selected indicator on an entire area of the display.

8. The display apparatus of claim 7, wherein the one or more instructions, when executed by the at least one processor, further cause the display apparatus to:
based on the priority of content corresponding to the selected indicator being higher than the priority of the remaining content, transmit through the communication interface information regarding the entire area to an apparatus that provides the content corresponding to the selected indicator.

9. The display apparatus of claim 1, wherein the one or more instructions, when executed by the at least one processor, further cause the display apparatus to:
identify at least one of a size or a resolution of the first area based on a type of the content.

10. The display apparatus of claim 1,
wherein the one or more instructions, when executed by the at least one processor, further cause the display apparatus to:
based on identifying that the electronic apparatus is connected to the display apparatus through the communication interface, transmit information regarding a size of the first area to the electronic apparatus through the communication interface, and
wherein a resolution of the content corresponding to the first area is based on the information regarding the size of the first area.

11. The display apparatus of claim 1, wherein the information regarding the adjusted size comprises extended display identification data regarding the adjusted size.

12. The display apparatus of claim 1, wherein the one or more instructions, when executed by the at least one processor, further cause the display apparatus to:
based on the size of the first area being adjusted, control the display to display a preset image on the first area.

13. A method of controlling a display apparatus, the method comprising:
displaying content received from an electronic apparatus on a first area of a display included in the display apparatus;
based on a size of the first area being adjusted according to a user command, transmitting information regarding the adjusted size to the electronic apparatus; and
based on receiving additional content corresponding to the resized first area from the electronic apparatus, displaying the additional content on the resized first area.

14. The method of claim 13, wherein a resolution of the additional content is based on the information regarding the adjusted size.

15. The method of claim 13, further comprising:
based on the user command is being input, providing a GUI for guiding adjustment of the size of the first area based on information received from the electronic apparatus regarding one or more available sizes.

16. The method of claim 13, further comprising:
displaying second content received from a second electronic apparatus on a second area of the display; and
displaying a task bar comprising an indicator corresponding to the content and a second indicator corresponding to the second content.

17. A display apparatus comprising:
a communication interface;
a display;
at least one memory storing one or more instructions; and
at least one processor connected to at least one memory, the communication interface and the display,
wherein the at least one processor is configured to execute the one or more instructions, and wherein the one or more instructions, when executed by the at least one processor, cause the display apparatus to:
control the display to display content received from an electronic apparatus through the communication interface on a first area of the display,
based on the size of the first area being adjusted according to a user command, identify whether the adjusted size corresponds to one of one or more available area sizes based on information regarding the one or more available area sizes received from the electronic apparatus through the communication interface,
based on the adjusted size corresponding to one of the one or more available area sizes, transmit information regarding the adjusted size to the electronic apparatus through the communication interface,
based on the adjusted size not corresponding to one of the one or more available area sizes, readjust the adjusted size to one of the one or more available area sizes and transmit information regarding the readjusted size to the electronic apparatus through the communication interface, and
based on receiving additional content corresponding to the resized first area from the electronic apparatus, control the display to display the additional content on the resized first area.
